(19) United States
(12) Patent Application Publication
(10) Pub. No.: US 2017/0243670 A1
(43) Pub. Date: Aug. 24, 2017

(54) CONDUCTING ELASTOMERS

(71) Applicants: Ilhan A AKSAY, Princeton, NJ (US); Kevin SALLAH, Princeton, NJ (US)

(72) Inventors: Ilhan A. AKSAY, Princeton, NJ (US); Kevin SALLAH, Princeton, NJ (US)

(21) Appl. No.: 15/502,714

(22) PCT Filed: Aug. 10, 2015
(86) PCT No.: PCT/US15/44430

§ 371 Date: Feb. 8, 2017

Related U.S. Application Data
(60) Provisional application No. 62/035,156, filed on Aug. 8, 2014.

(51) Int. Cl. H01B 1/24; C08J 3/205; H01B 13/00; C08K 3/04

(52) U.S. Cl. CPC H01B 1/24; C08K 3/04; C08K 3/042; C08J 3/2053; H01B 13/0036; H01B 13/0016; B82Y 40/00

(57) ABSTRACT

Embodiments of the present invention relate to conducting elastomers and associated fabrication methods. In one embodiment, the conducting elastomer comprises a filler powder and a polymer. The filler powder includes carbon black and functionalized graphene sheets. The polymer has a molecular weight of about 200 g/mol to about 5000 g/mol and is a liquid at room temperature.

### CROSS-REFERENCE TO RELATED APPLICATIONS

This application claims priority to U.S. Provisional Application No. 62/035,156 filed Aug. 8, 2014. This application is hereby incorporated herein by reference.

### BACKGROUND

The present invention relates generally to compositions of matter and specifically to conductive nanocomposites having an elastomeric matrix with functional graphene sheets and carbon black as fillers, methods of making the same and their use. Elastomers are typically natural or synthetic polymers having a plurality of amorphous chains that form random, thermodynamically favorable, conformations. Deformation or stretching of elastomers can straighten out the various conformations in the molecule. Elastomers typically return to their original state when the forces of deformation are removed. Attempts to achieve electrical conductivity and extensibility typically have utilized the incorporation of metallic nano particles, carbon nanotubes, electrospun polymer fibers, as well as layer-by-layer processing.

### BRIEF DESCRIPTION OF THE DRAWINGS

FIG. 1A compares engineering stress-strain behaviors of neat and filled composite samples, in accordance with an embodiment of the present invention.

FIG. 1B compares engineering stress-strain behaviors of neat and filled composite samples, in accordance with an embodiment of the present invention.

FIG. 2 compares electrical conductivity-strain behaviors of neat and filled composite samples, in accordance with an embodiment of the present invention.

### DETAILED DESCRIPTION

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Elastomers are typically natural or synthetic polymers having a plurality of amorphous chains that form random, thermodynamically favorable, conformations. Deformation or stretching of elastomers can straighten out the various conformations in the molecule. Elastomers typically return to their original state when the forces of deformation are removed. Attempts to achieve electrical conductivity and extensibility typically have utilized the incorporation of metallic nano particles, carbon nanotubes, electrospun polymer fibers, as well as layer-by-layer processing.

Disclosed herein are elastomer composites having carbon black particles and functionalized graphene sheets (“FGS”) as fillers. Elastomer composites of the present invention can exhibit electrical conductivities of greater than 1 S/m when subject to tensile strains of 100% or greater. The elastomer composites can exhibit an enhanced moduli and strength compared to corresponding unfilled elastomer compositions. As used herein, the term “unfilled” refers to corresponding elastomer compositions that lack carbon black and FGS.

Any carbon black can be utilized, for example, Ketjenblack EC600 as distributed by AkzoNobel. The functionalized graphene sheets can be prepared utilizing a plurality of methods, such as the method disclosed in U.S. Pat. No. 7,658,901 to Prud'Homme et al., hereby incorporated herein by reference. The elastomer composites can be prepared by mechanical mixing of carbon black. FGS, and polymer. For example, high-shear internal mixers, such as the Rheomix OS twin-screw mixer, can be utilized for such mixing.

The elastomer composites may be prepared using a solvent-processing procedure, such as disclosed in U.S. Patent Publication 2011/0178224 to Pan et al., hereby incorporated herein by reference. For example, a suspension can be prepared by dispersing the functionalized graphene sheets and carbon black particles in a solvent, such as tetrahydrofuran. Dispersions can be achieved by shaking, stirring, and/or sonication. Large clusters of particles can act as flaws to initiate premature termination of stretching. On the other hand, aggregated fillers may be effective as primary in enhancing the modulus and tensile strength of the elastomer. A broad array of polymers can be utilized in the present invention. For example, polymers having a molecular weight of about 200 g/mol to about 5,000 g/mol; polymers that behave as a liquid at room temperature; and/or polymers that can be cross-linked or end-linked. In certain embodiments, vinyl-terminated polydimethylsiloxane (“vinyl-PDMS”) is utilized. The polymer may be introduces to the suspension after dispersion to ensure that the desired amount of aggregation or dispersion is achieved. The suspension can be subjected to heat to evaporate the solvent and form a paste.

Cross-linking chemicals can be introduced into the paste and subsequently mixed therein, for example, mechanically. For example, where vinyl-PDMS is utilized, a multifunctional hydrosilane cross-linker and a platinum catalyst can be utilized. Films can be formed by pressing or calendaring the paste into a sheet, which promotes the enhanced characteristics of the composites. The sheet is allowed to dry at room temperature, or at an elevated temperature, for about 24 hours.

### Examples

Table 1 reflects the components of Examples 1, 2, and 3 (“the examples”), such as the elastomer matrix precursor, filler loadings, and preparation method, as well as two unfilled control samples used for mechanical property references. The examples utilize FGS powder, as supplied by Vorbeck Materials Corp., having an approximate carbon/oxygen ratio of 15. The carbon black used is Ketjenblack EC600 supplied by AksoNobel. The polymer utilized is vinyl-PDMS supplied by Gelest, Inc. in two different molecular weights having a viscosity of 200 cSt and 10,000 cSt.

TABLE 1

| | | Fillers | Composite |
|---|---|---|---|
| | Polymer used to | (Mass % FGS/ | paste |
| | form matrix | Mass % CB) | prepared by |
| Control 1 | Vinyl-PDMS* (200 cSt) | 0/0 | — |
| Example 1 | Vinyl-PDMS* (200 cSt) | 2/8 | Solvent |
| | | | processing |
| Control 2 | Vinyl-PDMS* (10,000 cSt) | 0/0 | — |
| Example 2 | Vinyl-PDMS* (10,000 cSt) | 3/12 | Solvent |
| | | | processing |
| Example 3 | Vinyl-PDMS* (10,000 cSt) | 3/12 | Rheomix |

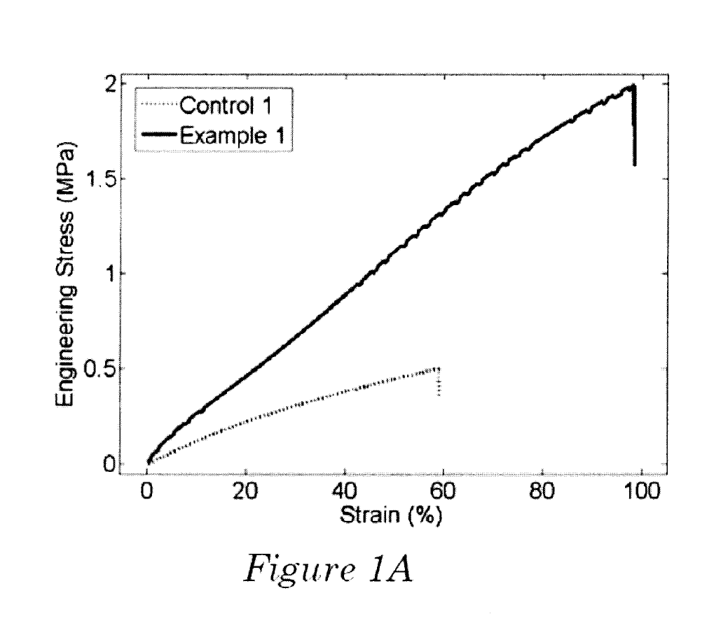

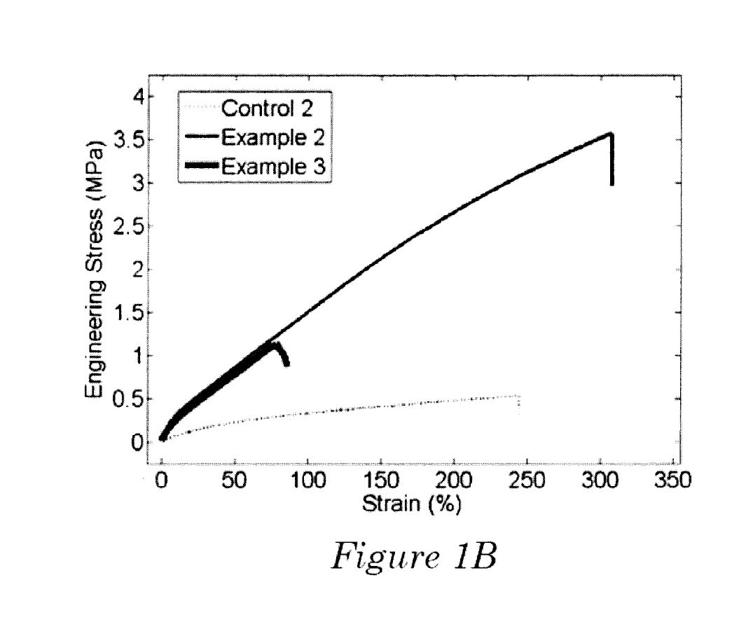

Controls 1 and 2 as well as Examples 1, 2, and 3 were each cross-linked using tetrakis(dimethylsiloxy)silane and platinum-cyclovinylmethylsiloxane complex. The composites were characterized by uniaxial tensile testing on an Instron 5567A. For each sample, three dog bones were strained until failure at a rate of 55 mm/min. Stress-strain data is illustrated in FIGS. 1A and 1B. In each case, the filled samples exhibit improved modulus and strength over the corresponding controls. Elongation increased for some cases, but in the case of Example 3, elongation decreased.

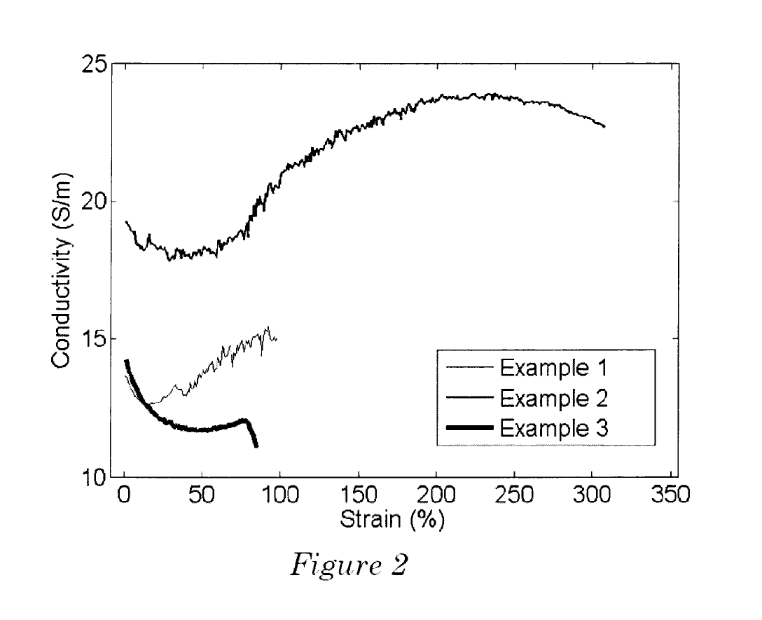

Two-point resistance measurements were performed simultaneously with tensile testing to yield resistance curves as a function of time. The conductivity-strain data is presented in FIG. 2. Electrical conductivities of greater than 10 S/m were achieved in all samples. Conductivity varies with strain and is not in general monotonic. Incompressibility was assumed for calculating conductivity at non-zero strains. Averaged sample properties are presented in Table 2. Young's Modulus is calculated by a least-square fitting of the true stress from 0-5% elongation. True strength presumed to be incompressible for calculations. Unexpected results of enhanced mechanical and electrical characteristics were achieved for Examples 1 and 2, which were derived using the solvent processing method of the present invention, compared Rheomix derived Example 3.

TABLE 2

| | | | | Electrical | Electrical |
|---|---|---|---|---|---|
| | Young's | Elongation | True | Conductivity | Conductivity |
| | Modulus | at Failure | Strength | at 0% Strain | at Failure |
| | (MPa) | (%) | (MPa) | (S/m) | (S/m) |
| Control 1 | 1.30 | 52 | 0.68 | — | — |
| Example 1 | 3.06 | 85 | 3.25 | 12.6 | 13.8 |
| Control 2 | 0.83 | 250 | 1.84 | — | — |
| Example 2 | 3.57 | 323 | 13.8 | 19.4 | 21.9 |
| Example 3 | 2.82 | 79 | 1.61 | 12.3 | 10.2 |

Examples 1, 2, and 3 have a nearly homogenous smooth appearance on both sides. Examples 1, 2, and 3 have an elongation at break of greater than about 79% and up to about 323%.

Applications of the present invention include, but are not limited to, conductive coatings and seals, which may be utilized for electromagnetic interference shielding and electrostatic charge dissipation. Applications may also include rubber components for tires, seals, high-strain sensors and actuators, as well as stretchable/flexible electronics.

As various modifications could be made in the constructions and methods herein described and illustrated without departing from the scope of the invention, it is intended that all matter contained in the foregoing description or shown in the accompanying drawings shall be interpreted as illustrative rather than limiting. Thus the breadth and scope of the present invention should not be limited by any of the above-described exemplary embodiments, but should be defined only in accordance with the following claims appended hereto and their equivalents.

What is claimed is:

1. A conducting elastomer comprising:
a filler powder;
a polymer;
wherein the filler powder includes carbon black and functionalized graphene sheets; and
wherein the polymer has a molecular weight of about 200 g/mol to about 5000 g/mol and is a liquid at room temperature.

2. The conducting elastomer of claim 1, wherein the conducting elastomer has an elongation at failure of up to about 323% as tested using an Instron 5567A.

3. The conducting elastomer of claim 1, wherein the conducting elastomer has an electrical conductivity at failure of up to about 21.9 S/m as tested using two point resistance measurements

4. The conducting elastomer of claim 1, further comprising a cross-linking molecule.

5. The conducting elastomer of claim 1, wherein the functionalized graphene sheets (“FGS”) and carbon black (“CB”) are present in a mass % FGS/mass % CB ratio of about 2/8 to about 3/12.

6. The conducting elastomer of claim 1, wherein the polymer has a viscosity of about 200 cSt to about 10,000 cSt.

7. A method of forming a conducting elastomer, the method comprising:
mixing a filler powder and polymer;
forming the filler powder and polymer into a sheet;
wherein the filler powder includes carbon black and functionalized graphene sheets;
wherein the polymer has a molecular weight of about 200 g/mol to about 5000 g/mol and is a liquid at room temperature.

8. The method of claim 7, wherein the conducting elastomer has an elongation at failure of up to about 323% as tested using an Instron 5567A.

9. The method of claim 7, wherein the conducting elastomer has an electrical conductivity at failure of up to about 21.9 S/m as tested using two point resistance measurements.

10. The method of claim 7, further comprising mixing a cross-linking molecule with the filler powder and polymer.

11. The method of claim 7, wherein the functionalized graphene sheets (“FGS”) and carbon black (“CB”) are present in a mass % FGS/mass % CB ratio of about 2/8 to about 3/12.

12. The method of claim 7, wherein the polymer has a viscosity of about 200 cSt to about 10,000 cSt.

13. A method of forming a conducting elastomer, the method comprising:
forming a suspension by dispersing functionalized graphene sheets and carbon black in a solvent;
mixing the suspension with a polymer capable of being cross-linked or end-linked;
heating the suspension to evaporate the solvent to form a conducting elastomer paste; and
wherein the polymer has a molecular weight of about 200 g/mol to about 5000 g/mol and is a liquid at room temperature.

14. A method of claim 13, wherein the solvent is tetrahydrofuran.

15. The method of claim 13, wherein the conducting elastomer has an elongation at failure of up to about 323% as tested using an Instron 5567A

16. The method of claim 13, wherein the conducting elastomer has an electrical conductivity at failure of up to about 21.9 S/m as tested using two point resistance measurements

17. The method of claim 13, further comprising mixing a cross-linking molecule with the filler powder and polymer.

18. The method of claim 13, wherein the functionalized graphene sheets (“FGS”) and carbon black (“CB”) are present in a mass % FGS/mass % CB ratio of about 2/8 to about 3/12.

19. The method of claim 13, wherein the polymer has a viscosity of about 200 cSt to about 10,000 cSt.
